(19) United States
(12) Patent Application Publication
(10) Pub. No.: US 2011/0122218 A1
(43) Pub. Date: May 26, 2011

(54) EXPOSURE HEAD AND IMAGE FORMING APPARATUS

(75) Inventors: Nozomu INOUE, Matsumoto (JP); Hiroaki JO, Suwa (JP); Ken IKUMA, Suwa (JP)

(73) Assignee: SEIKO EPSON CORPORATION, Tokyo (JP)

(21) Appl. No.: 12/899,820

(22) Filed: Oct. 7, 2010

(30) Foreign Application Priority Data
Nov. 25, 2009 (JP) 2009-267675

(51) Int. Cl. B41J 15/14

(52) U.S. Cl. 347/237

(57) ABSTRACT

An exposure head including: light-emitting elements disposed at a first pitch in a first direction; and drive circuits disposed at a second pitch wider than the first pitch in the first direction on one side of the light-emitting elements in a second direction orthogonal to or substantially orthogonal to the first direction and configured to cause the light-emitting elements to emit light.

### BACKGROUND

1. Technical Fields

The present invention relates to an exposure head configured to perform exposure using light emitted from light-emitting elements and an image forming apparatus using the exposure head.

2. Related art

An exposure head disclosed in JP-A-2009-160915 includes a plurality of light-emitting elements located at different positions in the longitudinal direction, and is provided with an imaging optical system so as to oppose the plurality of light-emitting elements. The exposure head described above are provided with circuits driving respective light-emitting elements. Light emitted from the light-emitting elements according to drive signals from the drive circuits forms an image by the imaging optical system. In this manner, spots of light are projected on a surface of a photosensitive drum and the like so as to control the exposure.

In order to achieve the exposure as described above satisfactorily, it is required to secure sufficient light quantity which is to be used for forming the spots. In order to do so, it is important to cause each of the plurality of light-emitting elements to emit light having sufficient light quantity.

### SUMMARY

An advantage of some aspects of the invention is to provide a technology which can realize satisfactory exposure by causing light-emitting elements to emit light with sufficient light quantity.

In order to achieve the above-described advantage, according to an aspect of the invention, there is provided an exposure head including: light-emitting elements disposed at a first pitch in a first direction; and drive circuits disposed at a second pitch wider than the first pitch in the first direction on one side of the light-emitting elements in a second direction orthogonal to or substantially orthogonal to the first direction and configured to cause the light-emitting elements to emit light.

In order to achieve the above-described advantage, there is provided an image forming apparatus according to the aspect of the invention, the image forming apparatus including: an exposure head having light-emitting elements disposed at a first pitch in a first direction; and a latent image carrier to be exposed to light emitted from the light-emitting elements, wherein the exposure head includes drive circuits disposed in the first direction at a second pitch wider than the first pitch on one side of the light-emitting elements in a second direction orthogonal to or substantially orthogonal to the first direction and configured to cause the light-emitting elements to emit light.

The exposure head and the image forming apparatus of the aspect of the invention configured as described above include the light-emitting elements disposed in the first direction and the drive circuits disposed in the first direction on one side of the light-emitting elements in the second direction, and the light-emitting elements are caused to emit light by the drive circuits. In this respect, the exposure head of the aspect of the invention is similar to the head disclosed in JP-A-2009-160915. However, in the configuration in which the drive circuits are disposed in the first direction on the one side of the light-emitting elements in the second direction with respect to the light-emitting elements disposed in the first direction, the drive circuits cannot be upsized. Therefore, current performances of the drive circuits are lowered, and hence the light quantity of the light-emitting elements may become short as a result. In contrast, in the aspect of the invention, the light-emitting elements are disposed at the first pitch in the first direction, and the drive circuits are disposed at the second pitch wider than the first pitch in the first direction. In other words, by disposing the drive circuits at the second pitch which is relatively wide, the drive circuits can be upsized to obtain the drive circuits having a high current performance. Accordingly, the light-emitting elements can be caused to emit light at sufficient light quantity, thereby achieving a satisfactory exposure.

In order to cause the light-emitting elements to emit light having the sufficient light quantity as a matter of course, and also to achieve the satisfactory exposure, it is also important to suppress variation in light quantity among the plurality of light-emitting elements disposed in the first direction and to keep the light quantity of the light-emitting elements within a predetermined range.

Therefore, the drive circuits may be disposed linearly in the first direction. In this configuration, the conditions of manufacture of the drive circuits are equalized among the respective drive circuits, so that the characteristics of the respective drive circuits can be substantially the same. Consequently, the light quantity of the respective light-emitting elements can be in the predetermined range.

In the configuration having contacts disposed in the first direction between the light-emitting elements and the drive circuits, in which the light-emitting elements and the drive circuits are electrically connected via the contacts, the contacts may be disposed linearly in the first direction. In this configuration, the conditions of manufacture of the drive circuits are equalized among the respective contacts, so that the characteristics of the respective contacts can be substantially the same. Consequently, the light quantity of the respective light-emitting elements can be in the predetermined range.

An exposure head according to another aspect of the invention includes first light-emitting elements disposed in a first direction; second light-emitting elements disposed on both sides of the first light-emitting elements in the first direction; and drive circuits configured to generate drive signals, and the first light-emitting elements are connected to the drive circuits and emit light according to the drive signals, while the second light-emitting elements are not connected to the drive circuits and do not emit light.

An image forming apparatus according to the aspect of the invention includes: an exposure head including first light-emitting elements disposed in a first direction, second light-emitting elements disposed on both sides of the first light-emitting elements in the first direction, and drive circuits configured to generate drive signals; and a latent image carrier, and the first light-emitting elements are connected to the drive circuits and emit light according to the drive signals to expose the latent image carrier, while the second light-emitting elements are not connected to the drive circuits and do not emit light.

The aspect of the invention configured as described above (the exposure head, the image forming apparatus) includes the first light-emitting elements disposed in the first direction. The light quantity of the light-emitting elements disposed in this manner is sensitive to the condition of manufacture as described below. In other words, since the conditions of manufacture are different from each other between the light-emitting element having different light-emitting elements on both sides and the light-emitting elements having a different light-emitting element only on one side, the light quantity of the light-emitting elements arranged at the both ends may be relatively lowered among the first light-emitting elements disposed in the first direction. Therefore, the first light-emitting elements at the both ends are used for exposure, and the first light-emitting elements may not be able to emit light having the sufficient light quantity, so that the satisfactory exposure may not be achieved. In contrast, according to the aspect of the invention, the second light-emitting elements are provided on both sides of the first light-emitting elements disposed in the first direction, and the conditions of manufacture of at least the respective first light-emitting elements are substantially equalized. On that basis, it is configured in such a manner that the first light-emitting elements are connected to the drive circuits and emit light according to the drive signals, while the second light-emitting elements are not connected to the drive circuits so as not emit light. In other words, only the first light-emitting elements being in the substantially same condition of manufacture and having the sufficient light quantity are used for the exposure, and the second light-emitting elements are not used for the exposure. Accordingly, the satisfactory exposure is achieved using the first light-emitting elements having the sufficient light quantity.

The first light-emitting elements and the second light-emitting elements may be organic electroluminescence (EL) elements having the same configuration. Accordingly, the conditions of manufacture of the first light-emitting elements disposed in the first direction can further be uniformized.

### BRIEF DESCRIPTION OF THE DRAWINGS

The invention will be described with reference to the accompanying drawings, wherein like numbers reference like elements.

FIG. 1 is a plan view showing an example of a line head to which an embodiment of the invention can be applied.

FIG. 2 is a partial cross-sectional view showing the example of the line head to which the embodiment of the invention can be applied.

FIG. 3 is a cross-sectional view of a light-shielding member taken along the line in FIG. 1.

FIG. 4 is an exploded perspective view of the light-shielding member.

FIG. 5 is a partial plan view showing a mode of arrangement of light-emitting elements in a light-emitting element group.

FIG. 6 is a drawing showing a circuit configuration of a drive circuit.

FIG. 7 is a block diagram showing an electric configuration of the line head.

FIG. 8 is a drawing showing an example of an image forming apparatus to which the line head can be applied.

FIG. 9 is a block diagram showing an electric configuration of the apparatus shown in FIG. 8.

### DESCRIPTION OF EXEMPLARY EMBODIMENTS

### First Embodiment

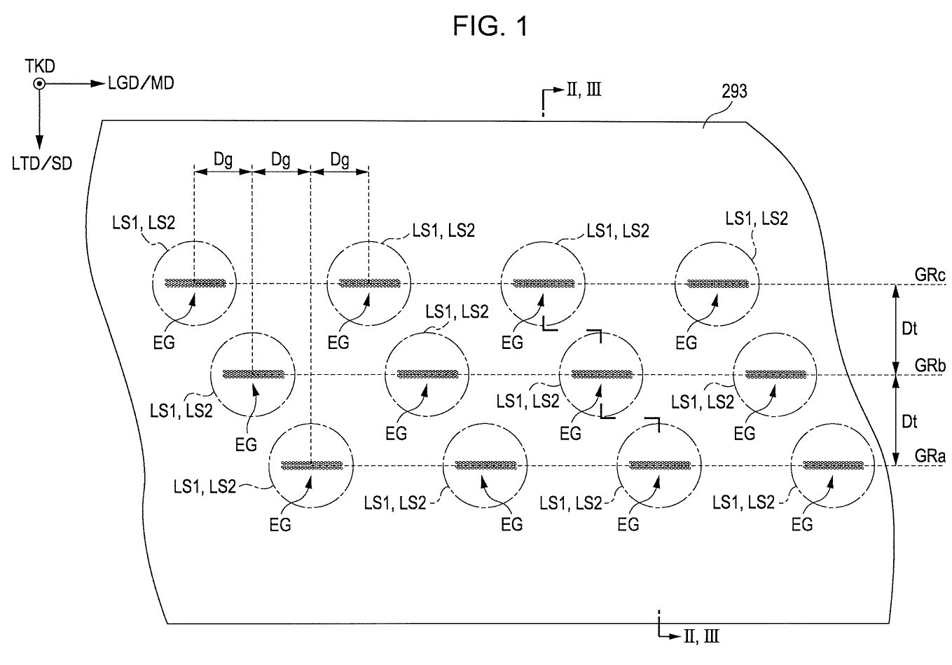

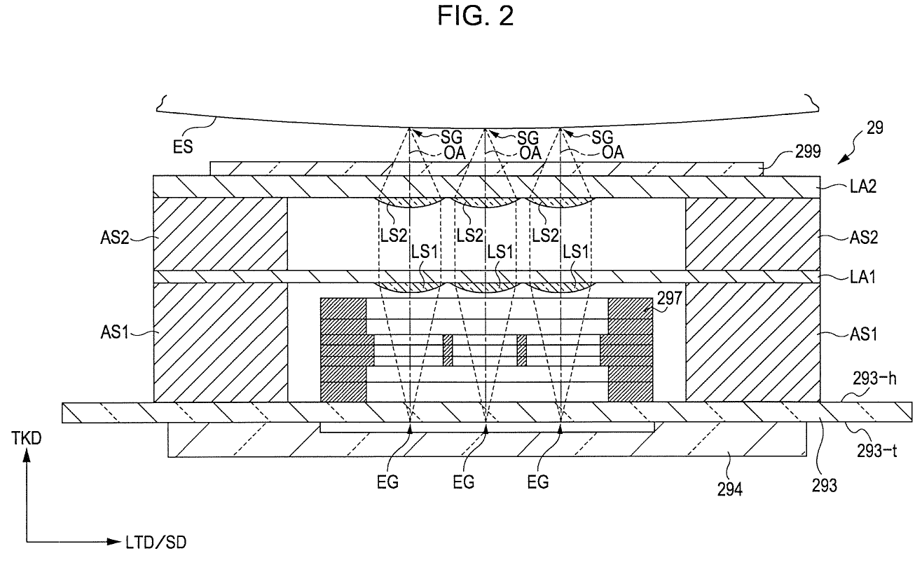

FIG. 1 and FIG. 2 are drawings showing an example of a line head to which the embodiment of the invention can be applied. In particular, FIG. 1 is a plan view of a positional relationship between light-emitting elements and lenses provided on a line head 29 viewed in a thickness direction TKD of the line head 29. FIG. 2 is a partial cross-sectional view of the line head 29 taken along the line II-II (chain double-dashed line in FIG. 1), which corresponds to a case where the cross-section is viewed in a longitudinal direction LGD of the line head 29. The line head 29 is long in the longitudinal direction LGD and short in a width direction LTD, and has a predetermined thickness (height) in the thickness direction TKD. In the drawings shown below including FIG. 1 and FIG. 2, the longitudinal direction LGD, the width direction LTD, and the thickness direction TKD of the line head 29 are shown as needed. These directions LGD, LTD, and TKD are orthogonal or substantially orthogonal to each other. In the following description, the side indicated by an arrow in the thickness direction TKD is expressed as “front” or “up”, and the side opposite from the direction of arrow in the thickness direction TKD is expressed as “back” or “down”.

As described later, when applying the line head 29 to an image forming apparatus, the line head 29 performs exposure with respect to an exposed surface ES (the surface of a photosensitive drum) moving in a secondary scanning direction SD, which is orthogonal or substantially orthogonal to a primary scanning direction MD. In addition, the primary scanning direction MD of the exposed surface ES is parallel to or substantially parallel to the longitudinal direction LGD of the line head 29 and the secondary scanning direction SD of the exposed surface ES is parallel to or substantially parallel to the width direction LTD of the line head 29. Therefore, the primary scanning direction MD and the secondary scanning direction SD will also be indicated together with the longitudinal direction LGD and the width direction LTD as needed.

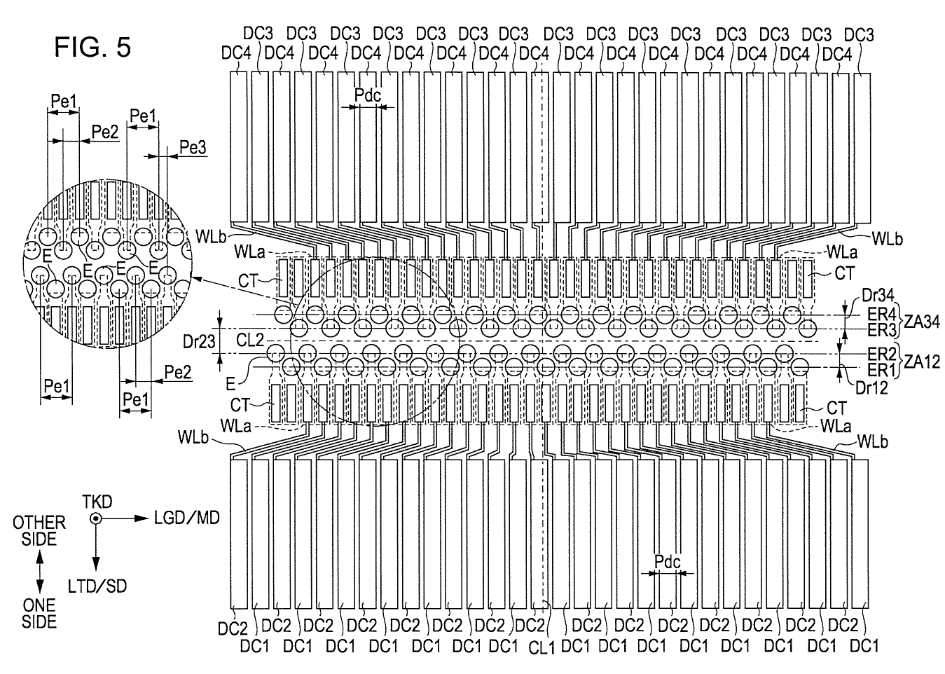

In the line head 29 according to a first embodiment, a plurality of light-emitting elements E are grouped to constitute one light-emitting element group EG (a mode of arrangement of the light-emitting elements E will be described in detail later with reference to FIG. 5), and a plurality of the light-emitting element groups EG are arranged dispersedly in a zigzag pattern (three-row zigzag pattern) (FIG. 1). In this manner, the plurality of light-emitting element groups EG are arranged by being shifted by a distance Dg in the longitudinal direction LGD with respect to each other, and being shifted by a distance Dt in the width direction LTD with respect to each other. In a way, it can be said that light-emitting element group rows GR each including the plurality of light-emitting element groups EG, which are arranged linearly in the longitudinal direction, are arranged in three rows GRa, GRb, and GRc at different positions in the width direction LTD.

The respective light-emitting elements E are bottom-emission type organic EL elements having the same light-emitting spectrum each other. In other words, organic EL elements which constitute the respective light-emitting elements E are formed on a back surface 293-t of a head substrate 293, which is a glass plate being long in the longitudinal direction LGD and short in the width direction LTD, and are sealed with a glass-made sealing member 294. The sealing member 294 is fixed to the back surface 293-t of the head substrate 293 with an adhesive agent.

One imaging optical system opposes each of the plurality of light-emitting element groups EG. The imaging optical system includes two lenses LS1 and LS2 being convex toward the light-emitting element groups EG. In FIG. 1, the lenses LS1 and LS2 are shown by chain line circles. However, they are intended to show the positional relationship between the light-emitting element groups EG and the lenses LS1 and LS2 in plan view in the thickness direction TKD, and are not intended to show that the lenses LS1 and LS2 are formed directly on the head substrate 293. In FIG. 2, a member 297 is illustrated between the light-emitting element groups EG and the imaging optical systems LS1 and LS2. This will be described after the description of the imaging optical system.

In the line head 29, in order to arrange the lenses LS1 and LS2 so as to oppose the plurality of light-emitting element groups EG arranged in three-row zigzag pattern respectively, a lens array LA1 having a plurality of the lenses LS1 arranged in three-row zigzag pattern and a lens array LA2 having a plurality of the lenses LS2 arranged in three-row zigzag pattern are provided. In other words, in the lens array LA1 (LA2), the plurality of lenses LS1 (LS2) are arranged so as to be shifted from each other by the distance Dg in the longitudinal direction LGD and are shifted from each other by the distance Dt in the width direction LTD, respectively.

The lens array LA1 (LA2) can be obtained by forming the resin lenses LS1 (LS2) on a light-transmissive glass plate. In this embodiment, considering the fact that it is difficult to manufacture the lens array LA1 (LA2) elongated in the longitudinal direction LGD in an integral configuration, the resin lenses LS1 (LS2) are arranged in three-row zigzag pattern on the relatively short glass plate to manufacture a single short lens array, and a plurality of the short lens arrays are arranged in the longitudinal direction LGD, thereby forming the lens array LA1 (LA2) elongated in the longitudinal direction LGD.

More specifically, spacers AS1 are arranged on a front surface 293-h of the head substrate 293 at both end portions thereof in the width direction LTD and the plurality of short lens arrays are arranged so as to extend between the spacers AS1 and AS1 respectively in the longitudinal direction LGD, so that the single lens array LA1 is formed. Spacers AS2 are arranged on the surface of the lens array LA1 on both sides thereof in the width direction LTD and the plurality of short lens arrays are arranged so as to extend between the spacers AS2 and AS2 respectively in the longitudinal direction LGD, so that the single lens array LA2 is formed. In addition, a flat-panel-shaped supporting glass 299 is bonded to the surface of the lens array LA2, so that the respective short lens arrays which constitute the lens array LA2 are supported not only by the spacers AS2, but also by the supporting glass 299 from the opposite side from the spacers AS2. The supporting glass 299 also has a function to cover the lens array LA2 so that the lens array LA2 is not exposed to the outside.

In this manner, in the thickness direction TKD, the lens arrays LA1 and LA2 which are arranged at a predetermined distance oppose the head substrate 293. Accordingly, the imaging optical systems LS1 and LS2 having optical axes OA parallel to or substantially parallel to the thickness direction TKD oppose the light-emitting element groups EG. Therefore, light emitted from the respective light-emitting elements E of the light-emitting element group EG transmit the head substrate 293, the imaging optical systems LS1 and LS2, and a supporting glass SS in sequence and is directed on the exposed surface ES (broken line in FIG. 2). Accordingly, the light from the respective light-emitting elements E of the light-emitting element group EG receive an imaging action from the imaging optical systems LS1 and LS2 and are directed on the exposed surface ES as spots, so that a spot group SG including a plurality of the spots is formed on the exposed surface ES. Here, the imaging optical systems LS1 and LS2 are a minification and inversion optical system (having a negative imaging magnification) having an imaging magnification of 1 or smaller in absolute value and forming an inverted image.

As is understood from the description shown above, the line head 29 in the first embodiment includes the imaging optical systems LS1 and LS2 specific for the respective plurality of light-emitting element groups EG arranged therein. In the line head 29 in this configuration, light from the light-emitting element group EG preferably enter only the imaging optical systems provided in the light-emitting element group EG, but do not enter other imaging optical systems. Accordingly, in the first embodiment, the light-shielding member 297 is provided between the front surface 293-h of the head substrate 293 and the lens array LA1.

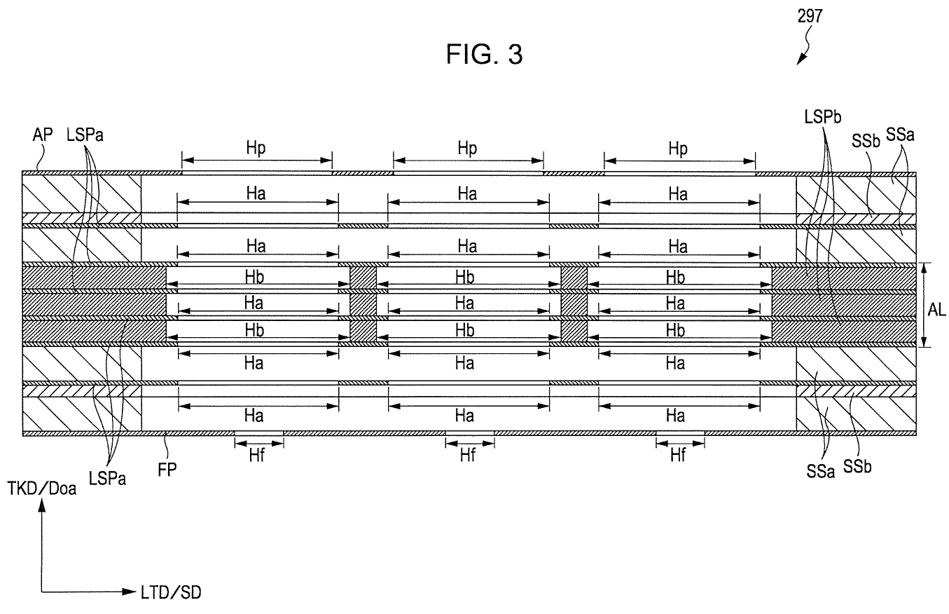

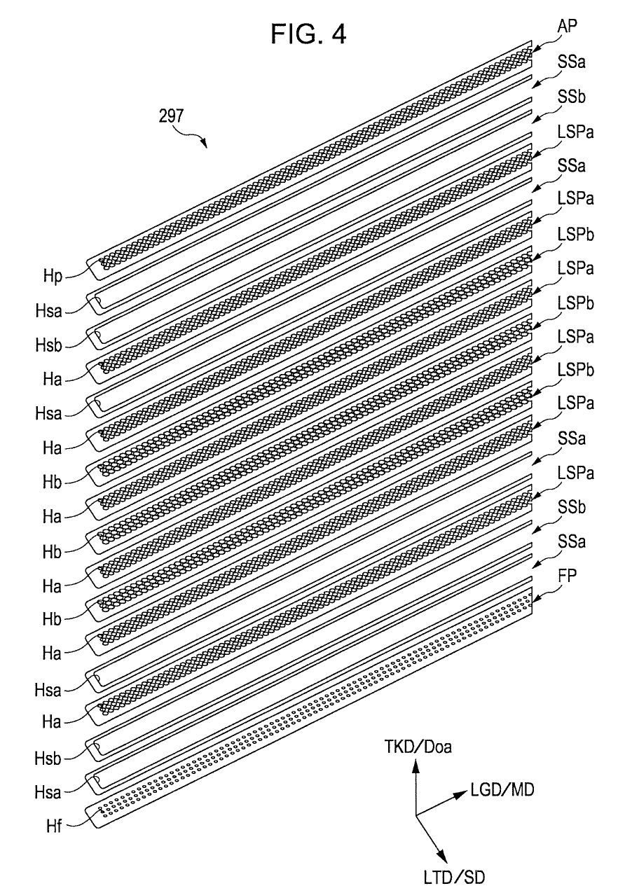

FIG. 3 is a cross-sectional view of the light-shielding member taken along the line III-III in FIG. 1, and FIG. 4 is an exploded perspective view of the light-shielding member. In these drawings, a light-traveling direction Doa is set to a direction parallel to the optical axes OA and directed from the light-emitting element group EG to the exposed surface ES (the light-traveling direction Doa extends parallel to or substantially parallel to the thickness direction TKD). As shown in these drawings, the light-shielding member 297 has a configuration including a first light-shielding panel FP, a second light-shielding panel LSPa, a third light-shielding panel LSPb and an aperture panel AP, and a first spacer SSa and a second spacer SSb which define the distance among these panels FP, LSPa, LSPb, and AP. More specifically, these panels and the spacers are laminated and fixed with an adhesive agent in the thickness direction TKD.

The panels FP, LSPa, LSPb, and AP are all have a function to allow passage of part of the light from the light-emitting element group EG and block passage of other light therethrough, and include openings Hf, Ha, Hb, and Hp between the light-emitting element groups EG and the imaging optical systems LS1 and LS2 opposing the same. The openings Hf, Ha, Hb, and Hp are respectively positioned so that the geometrical centers of gravity thereof match or substantially match the optical axes of the imaging optical systems LS1 and LS2. In other words, as shown in FIG. 3 and FIG. 4, circular openings Hf, Ha, Hb, and Hp are arranged in three-row zigzag pattern on the panels FP, LSPa, LSPb, and AP, respectively so as to penetrate therethrough in the thickness direction TKD corresponding to the three-row zigzag pattern of the light-emitting element groups EG. Portions of the light emitted from the light-emitting element groups EG, which pass through the openings Hf, Ha, Hb, and Hp, enter the imaging optical systems LS1 and LS2, and most of other portions of the light are blocked by the panels FP, LSPa, LSPb, and AP. The thicknesses of the panels FP, LSPa, LSPb, and AP satisfy the following relationship; FP≈AP≈LSPa<LSPb, and the diameter of the respective openings satisfy the following relationship Hf<Hp<Ha<Hb.

The spacers SSa and SSb are frame bodies having substantially rectangular-shaped elongated holes Hsa and Hsb formed so as to penetrate therethrough in the thickness direction TKD. The elongated holes Hsa and Hsb are formed to have dimensions which are large enough to embrace the respective openings Hf, Ha, Hb, and Hp completely therein in plan view of the light-shielding member 297 when seeing therethrough in the thickness direction TKD. Therefore, the light emitted from the respective light-emitting element groups EG travel through the elongated holes Hsa and Hsb toward the exposed surface ES (FIG. 2).

Subsequently, the mode of arrangement of the light-shielding member 297 will be described more specifically. The first light-shielding panel FP is placed on and fixed to the front surface 293-h (FIG. 2) of the head substrate 293, and the second light-shielding panel LSPa is arranged on the side of the light-traveling direction Doa of the first light-shielding panel FP. Two spacers SSa and SSb are interposed between the first light-shielding panel FP and the second light-shielding panel LSPa. A stray light absorbing layer AL is formed of two types of the panels on the side of the light-traveling direction Doa of the second light-shielding panel LSPa, and the first spacer SSa is interposed between the second light-shielding panel LSPa and the stray light absorbing layer AL. The stray light absorbing layer AL includes two types of the light-shielding panels LSPa and LSPb different in diameter of opening and thickness laminated alternately in the light-traveling direction Doa. More specifically, it includes the four second light-shielding panels LSPa and the three third light-shielding panels LSPb. The second light-shielding panel LSPa and the aperture panel AP are arranged in the light-traveling direction Doa in this order on the side of the light-traveling direction Doa of the stray light absorbing layer AL. The spacer SSa is interposed between the stray light absorbing layer AL and the second light-shielding panel LSPa, and the two spacers SSa and SSb are interposed between the second light-shielding panel LSPa and the aperture panel AP.

With the provision of the light-shielding member 297 in this manner, a plurality of the openings Hf, Ha, Hb, and Hp are arranged in the light-traveling direction Doa between the respective light-emitting element groups EG and the imaging optical systems LS1 and LS2 opposing the same. Consequently, the portions of the light emitted from the light-emitting element group EG, which pass through the openings Hf, Ha, Hb, and Hp opposing the light-emitting element group EG, reach the imaging optical systems LS1 and LS2, and most of other portions of the light are shielded by the light-shielding panels FP, LSPa, LSPb, and Ap and hence do not reach the imaging optical systems LS1 and LS2. Accordingly, desirable exposure without being affected by ghost is achieved.

Subsequently, the mode of arrangement of the light-emitting elements E in the light-emitting element group EG will be described. FIG. 5 is a partial plan view showing the mode of arrangement of light-emitting elements in the light-emitting element group. A chain line circle at a left end of the drawing is an excerpt of a range surrounded by a chain line circle shown at the substantially center of the drawing. FIG. 5 shows a configuration of the back surface 293-t of the head substrate 293 and elements shown in this drawing are formed on the back surface 293-t of the head substrate 293. As shown in the same drawing, the seventeen light-emitting elements E are linearly arranged at a pitch Pe1 in the longitudinal direction LGD to constitute one light-emitting element row ER. The one light-emitting element group EG includes four light-emitting element rows ER1 to ER4 arranged at different positions in the width direction LTD. More specifically, the light-emitting element group EG has a following mode of arrangement of the light-emitting element E.

The light-emitting element row ER1 and the light-emitting element row ER2 are shifted from each other by a pitch Pe2 (=Pe1/2) in the longitudinal direction LGD. Consequently, the light-emitting elements E belonging to the light-emitting element row ER1 and the light-emitting elements E belonging to the light-emitting element row ER2 are arranged in a zigzag pattern alternately in the longitudinal direction LGD at the pitch Pe2. In the same manner, the light-emitting element row ER3 and the light-emitting element row ER4 are shifted from each other by the pitch Pe2 in the longitudinal direction LGD. Consequently, the light-emitting elements E belonging to the light-emitting element row ER3 and the light-emitting elements E belonging to the light-emitting element row ER4 are arranged alternately in the longitudinal direction LGD at the pitch Pe2 in a zigzag pattern. A zigzag arrangement ZA12 including the light-emitting elements E in the light-emitting element rows ER1 and ER2 and a zigzag arrangement ZA34 including the light-emitting elements E in the light-emitting element rows ER3 and ER4 are shifted from each other by a pitch Pe3 (=Pe2/2) in the longitudinal direction LGD. Consequently, the four light-emitting elements E belonging to the light-emitting element rows ER2, ER4, ER1, and ER3 are arranged cyclically in this order in the longitudinal direction LGD at the pitch Pe3.

Here, for example, the pitch of the light-emitting elements E in the longitudinal direction LGD is obtained as a distance between the geometrical centers of gravity of the two light-emitting elements E and E arranged at the corresponding pitch in the longitudinal direction LGD.

Distances Dr12, Dr34, and Dr23 between the four light-emitting element rows ER1 to ER4 in the light-emitting element group EG in the width direction LTD are as follows. In other words, the distance Dr12 between the light-emitting element row ER1 and the light-emitting element row ER2, the distance Dr23 between the light-emitting element row ER2 and the light-emitting element row ER3, and the distance Dr34 between the light-emitting element row ER3 and the light-emitting element row ER4 satisfy ratios of whole numbers. In other words, the following equation; Dr12:Dr23:Dr34=l:m:n (l, m, and n are positive natural numbers) is satisfied. In particular, in the first embodiment, Dr12:Dr23:Dr34=l:m:n=2:3:2 is satisfied. Reasons why the light-emitting element rows ER1 to ER4 are arranged so as to satisfy the relationship of the ratio of whole numbers will be described.

By setting a lateral magnification β of the imaging optical system to an adequate value, relationships Dr12×|β|=2×Pdt, Dr23×|β|=3×Pdt, Dr34×|β|=2×Pdt, where Pdt represents pixel pitches on the exposed surface ES, can be established. If these relationships are established, the distance between a row SR1 of spots SP arranged linearly in the primary scanning direction MD formed by light emitted by the respective light-emitting elements E of the light-emitting element row ER1 and a row SR2 of spots SP arranged linearly in the primary scanning direction MD by light emitted by the respective light-emitting elements E of the light-emitting element row ER2 in the secondary scanning direction SD is integral multiples of (twice) a pixel pitch Pdt. In other words, the light-emitting element rows ER1 and ER2 arranged at the distance Dr12 form the spot rows SR1 and SR2 arranged in the secondary scanning direction SD at a distance of integral multiples of the pixel pitch Pdt. In the same manner, the light-emitting element rows ER2 and ER3 arranged at the distance Dr23 and the light-emitting element rows ER3 and ER4 arranged at the distance Dr34 also form the spot rows SR2, SR3 and SR4 so as to satisfy the same positional relationship. Therefore, only by illuminating the light-emitting element rows ER1 to ER4 simultaneously, the spot rows SR1 to SR4 can be formed adequately on the pixels, so that the light-emitting timing control is simplified.

The distances Dr12, Dr23 and Dr34 of the light-emitting element rows ER1 to ER4 become; Dr12=2×Pdt/|β|, Dr23=3×Pdt/|β|, Dr34=2×Pdt/|β|. Then, in order to secure the dimensions of a light-emitting unit of the respective light-emitting elements E of the respective light-emitting element rows ER1 to ER4, it is preferable to secure the distances Dr12, Dr23, and Dr34 at least to some extent. More specifically, the distance Dr12 between the light-emitting element rows ER1 and ER2 shifted from each other in the primary scanning direction MD by the light-emitting element pitch Pe2 or the distance Dr34 between the light-emitting element rows ER3 and ER4 is preferably set to be larger than Pdt/|β|, and the distance Dr23 between the light-emitting element rows ER2 and ER3 shifted from each other in the primary scanning direction MD by the light-emitting element pitch Pe3 (=Pe/2) is preferably set to be larger than 2×Pdt/|β|. Therefore, the distances Dr12, Dr23 and Dr34 are set to satisfy Dr12=2×Pdt/|β|, Dr23=3×Pdt/|β|, Dr34=2×Pdt/|β|. The reason why the preferable values of the distances Dr12, Dr23, and Dr34 are different depending on the shifted amounts (Pe2, Pe3) in the primary scanning direction MD is because the smaller the shifted amount in the primary scanning direction MD, the more likely the distance between the respective light-emitting elements E of the light-emitting element rows ER1, ER2 and ER3 is reduced, and hence the distance between the light-emitting element rows needs to be set long in the secondary scanning direction SD for securing the dimensions of the light-emitting elements E.

Here, for example, the distance Dr12 is obtained as a distance between an imaginary line passing through the geometrical centers of gravity of the light-emitting elements E of the light-emitting element row ER1 and extending in parallel to the longitudinal direction LGD and an imaginary line passing through the geometrical centers of gravity of the light-emitting elements E of the light-emitting element row ER2 and extending in parallel to the longitudinal direction LGD in the width direction LTD. The distances Dr23 and Dr34 are obtained in the same manner.

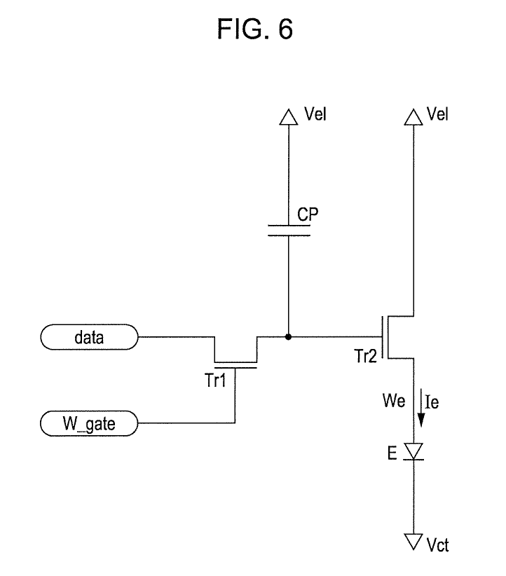

Arranged on one side of the light-emitting element group EG in the width direction LTD are drive circuits DC1 and DC2 that drive the plurality of light-emitting elements E which belong to the light-emitting element rows ER1 and ER2 and constitute the zigzag arrangement ZA12. More specifically, the drive circuits DC1 that drive the light-emitting elements E of the light-emitting element row ER1 and the drive circuits DC2 that drive the light-emitting elements E of the light-emitting element row ER2 are arranged alternately in the longitudinal direction LGD. The drive circuits DC1, DC2, . . . are arranged linearly in the longitudinal direction LGD at a pitch Pdc (>Pe2). In other words, the drive circuits DC1 and DC2 are arranged at the pitch Pdc which is larger than the pitch Pe2 at which the light-emitting elements E are arranged in the zigzag arrangement ZA12. The drive circuits DC1 and DC2 each are formed of a TFT (thin film transistor) and configured to hold a signal value written by a driver IC 295, described later, temporarily (more specifically, to store the voltage value as signal values in a capacitor) and supply a drive current according to the corresponding signal value to the light emitting elements E. A detailed circuit configuration of the drive circuits DC (DC1 to DC4) is shown in FIG. 6.

FIG. 6 is a drawing showing the circuit configuration of the drive circuit. The drive circuit DC is provided with a data terminal data to which a light quantity data Sd (voltage value) as a signal value is fed and a capacitor CP to which the light quantity data Sd which is fed to the data terminal data is written. In addition, the drive circuit DC is provided with a gate terminal W_gate to which gate signals Sg are fed. In other words, in order to write data to the capacitor CP by time division, the drive circuit DC is provided with the gate terminal W_gate for identifying the capacitor CP as a target of writing, so that the writing to the capacitor CP is performed at time division timings given by the gate signals Sg.

The drive circuit DC is provided with a first transistor Tr1 as a low-temperature polysilicon thin film transistor. Then, the data terminal data is connected to a source of the first transistor Tr1, while one end of the capacitor CP is connected to a drain of the first transistor Tr1 (the other end of the capacitor CP is connected to a drive circuit power voltage Ve1). The gate terminal W_gate is connected to a gate of the first transistor Tr1, so that ON/OFF control of the first transistor Tr1 can be performed with the input signal fed to the gate terminal W_gate. Therefore, the light quantity data Sd fed to the data terminal data is written to the capacitor CP while the ON signal is fed to the gate terminal W_gate, and the already written light quantity data Sd is continuously retained in the capacitor CP irrespective of the voltage value of the data terminal data while the OFF signal is fed to the gate terminal W_gate. The writing actions are performed at a certain cycle repeatedly. However, since the capacitor CP is sufficiently large, the voltage change of the capacitor CP during the respective writing actions does not actually occur.

The drive circuit DC is further provided with a second transistor Tr2 as a low polysilicon thin film transistor. A source of the second transistor Tr2 is connected to the drive circuit power voltage Ve1, and a drain of the second transistor Tr2 is connected to (an anode side of) the light-emitting element E by a wiring We. The one end of the capacitor CP described above is connected to a gate of the second transistor Tr2, and the second transistor Tr2 outputs a drive current Ie according to the voltage value of the capacitor CP from the drain. Therefore, since the second transistor Tr2 supplies the drive current Ie to the light-emitting element E while the drive voltage is retained in the capacitor CP, the light-emitting element E emits light having light quantity according to the drive current Ie. In contrast, since the second transistor Tr2 blocks the supply of the drive current Ie to the light-emitting element E while a light-out voltage is retained in the capacitor CP, the light-emitting element E puts the light out.

The voltage (drive voltage) applied to the organic EL element as the light-emitting element E depends on the potential difference between the drive circuit power voltage Ve1 and a voltage Vct connected to a cathode side of the light-emitting element E. The organic EL element has a resistance larger than a general inorganic LED (Light Emitting Diode), the drive voltage needs the order of 6 to 16 [V]. In addition, there may be a case where a drive voltage of 20 [V] or higher is necessary when prospect various margins. Also, when a withstand voltage of TFT does not accommodate such the high drive voltage, the voltage Vct may be set to a minus voltage instead of 0 [V].

Referring back to FIG. 5, description will be continued. Formed between the light-emitting elements E which constitute the zigzag arrangement ZA12 and the drive circuits DC1, DC2, . . . in the width direction LTD are a plurality of contacts CT. The plurality of contacts CT are provided adjacent to the plurality of light-emitting elements E which constitute the zigzag arrangement ZA12 in one-to-one correspondence, and are linearly arranged in the longitudinal direction LGD at the same pitch Pe2 as the plurality of light-emitting elements E. The respective light-emitting elements E which constitute the zigzag arrangement ZA12 and the contacts CT adjacent to the light-emitting elements E are connected by wirings WLa (broken lines in FIG. 5).

As shown in FIG. 5, the wirings WLa which connect the light-emitting elements E of the light-emitting element row ER1 and the contacts CT have a substantially constant width. In contrast, the width of the wirings WLa which connects the light-emitting elements E of the light-emitting element row ER2 and the contacts CT are not constant, and distal end portions on the side of the light-emitting elements E have a narrower width. It is because the wirings WLa are to be extend between the light-emitting elements E of the light-emitting element row ER1 up to the light-emitting elements E of the light-emitting element row ER2. In other words, by reducing the width of portions of the wirings WLa passing between the light-emitting elements of the light-emitting element row ER1 and remaining the thickness of other portions of the wirings WLa, resistance (wiring resistance) of the wiring WLa is restrained to a low value.

Then, the contacts CT connected to the light-emitting elements E of the light-emitting element row ER1 and the drive circuits DC1 are connected by wirings WLb. Also, the contacts CT connected to the light-emitting elements E of the light-emitting element row ER2 and the drive circuits DC2 are connected by the wirings WLb. In this manner, the drive circuits DC1 and DC2 and the light-emitting elements E are electrically connected via the contacts CT. Through these wiring paths, the drive circuits DC1 and DC2 supply the drive current Ie to the corresponding light-emitting elements E.

As shown in FIG. 5, the drive circuits DC1 and DC2 are not connected to the light-emitting elements E which are formed two each at both end portions in the longitudinal direction LGD from among the plurality of light-emitting elements E which constitute the zigzag arrangement ZA12. In other words, these light-emitting elements E are dummy elements E which do not receive supply of the drive current, and hence do not emit light in fact. In other words, the dummy elements E are provided one each at both end portions of the light-emitting element row ER1 in the longitudinal direction LGD, and one each at both end portions of the light-emitting element row ER2 in the longitudinal direction LGD. These dummy elements E are the organic EL elements having the same configuration as the light-emitting elements E which actually emit the light.

In the same manner, the plurality of drive circuits are arranged in the longitudinal direction LGD at the pitch Pdc (>Pe2) on the other side of the light-emitting element group EG in the width direction LTD. These drive circuits DC3 and DC4 are provided for driving the plurality of light-emitting elements E which belong to the light-emitting element rows ER3 and ER4 and constitute the zigzag arrangement ZA34. The relationship between the drive circuits DC3 and DC4 and the light-emitting element rows ER3 and ER4 (the zigzag arrangement ZA34) is the same as the relationship between the drive circuits DC1 and DC2 and the light-emitting element rows ER1 and ER2 (the zigzag arrangement ZA12) described above, and hence detailed description will be omitted.

In this manner, in the first embodiment, a plurality of the drive circuits DC arranged in one row in the longitudinal direction LGD are provided on both sides (one side and the other side) of the light-emitting element group EG in the width direction LTD, respectively. In this configuration, in comparison with the case where the drive circuits DC are arranged only on one side of the light-emitting element group EG in the width direction LTD, the number of the drive circuits DC arranged in one row in the longitudinal direction LGD may be reduced by half. Consequently, when a wider arrangement pitch Pdc of the drive circuits DC arranged in one row can be secured, so that the drive circuits DC can be upsized to obtain the drive circuits DC having a high current performance.

In this manner, the drive circuits DC1 to DC4 are connected to the light-emitting elements E of the light-emitting element group EG, and the respective light-emitting elements E emit light upon receipt of supply of the drive current Ie from the drive circuits DC1 to DC4. The current supply by the drive circuits DC1 to DC4 is controlled by the electric configuration of the line head 29.

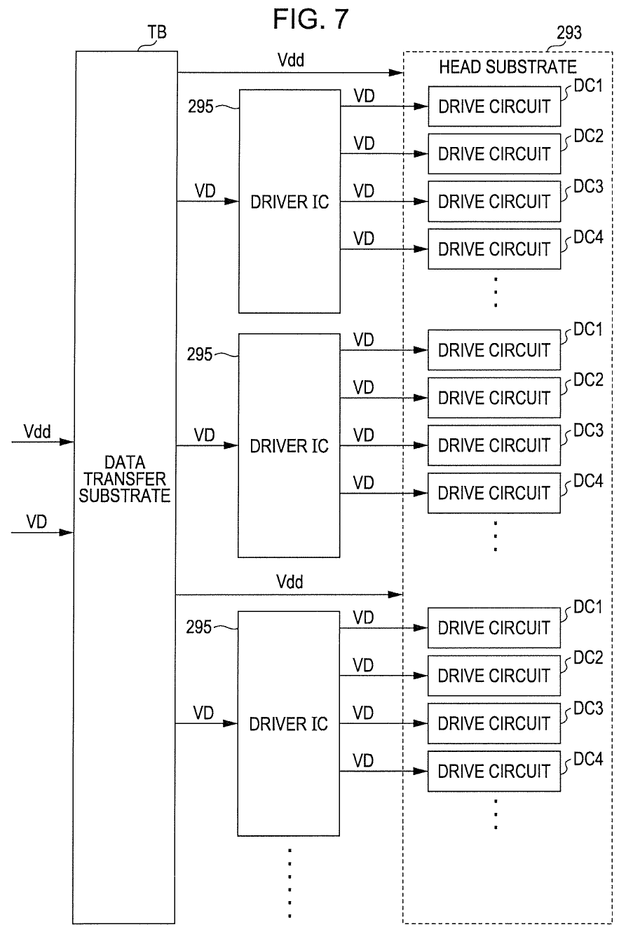

FIG. 7 is a block diagram showing an electric configuration of the line head. As shown in FIG. 7, the electric configuration of the line head 29 includes a data transfer substrate TB and a plurality of the driver ICs 295 in addition to the drive circuits DC1 to DC4 described above. The data transfer substrate TB transfers video data VD received from the outside to the respective driver ICs 295. The respective driver ICs 295 write the video data VD (more specifically, the video data VD converted into voltage values) into the drive circuits DC1 to DC4 as the above-described light quantity data Sd, and control the light emission of the light-emitting elements E. At this time, the driver ICs 295 may write the video data VD amended according to deteriorations or temperature characteristics of the light-emitting elements E into the drive circuits DC1 to DC4 as the light quantity data Sd. The data transfer substrate TB also serves to supply a power source Vdd supplied from the outside to (the drive circuits DC1 to DC4 of) the head substrate 293.

As described above, in the first embodiment, the zigzag arrangement ZA12 (ZA34) are configured by arranging the plurality of light-emitting elements E in the longitudinal direction LGD in a zigzag pattern, and a plurality of the drive circuits DC1 and DC2 (DC3 and DC4) are arranged in one row in the longitudinal direction LGD on the one side (the other side) of the zigzag arrangement ZA12 (ZA34) in the width direction LTD. The respective drive circuits DC1 and DC2 supply drive signals (drive current Ie) to the light-emitting elements E and cause the light-emitting elements E to emit light. In this configuration, the drive circuits DC1 and DC2 (DC3 and DC4) cannot be formed to have large dimensions, the current performances of the drive circuits DC1 and DC2 (DC3 and DC4) become low. Therefore, the light quantity of the light-emitting elements E may become short. In contrast, in the line head 29 in the first embodiment, the light-emitting elements E are arranged at the pitch Pe2 (first pitch) in the longitudinal direction LGD and the drive circuits DC1 and DC2 (DC3 and DC4) are arranged at a pitch Pdc (second pitch) larger than the pitch Pe2 in the longitudinal direction LGD. In other words, by arranging the drive circuits DC1 and DC2 (DC3 and DC4) at the relatively large pitch Pdc, the drive circuits DC1 and DC2 (DC3 and DC4) can be upsized, so that the drive circuits DC1 and DC2 (DC3 and DC4) having a large current performance can be formed. Accordingly, the light-emitting elements E can be caused to emit light having sufficient light quantity, thereby achieving a satisfactory exposure.

When changing the point of view, the layout of “drive circuit pitch Pdc>light-emitting element pitch Pe2” has a following advantage. In other words, by arranging the light-emitting elements E in the longitudinal direction LGD at the relatively narrow pitch Pe2, the light-emitting element group EG can be configured to be small in the longitudinal direction LGD. Therefore, relatively wide spaces can be provided on both sides of the light-emitting element group EG in the longitudinal direction LGD, and the spaces can be used effectively as needed. In particular, this layout can be said to be satisfactory for the configuration having the dummy elements E on both ends of the light-emitting element group EG in the longitudinal direction LGD as described above.

In order to cause the light-emitting elements E to emit light having the sufficient light quantity as a matter of course, and also to achieve the satisfactory exposure, it is also important to suppress variation in light quantity among the plurality of light-emitting elements E arranged in the longitudinal direction LGD and to keep the light quantity of the respective light-emitting elements E within a predetermined range.

Therefore, in the first embodiment, the drive circuits DC1 and DC2 (DC3 and DC4) are arranged linearly in the longitudinal direction LGD. In this configuration, the conditions of manufacture of the drive circuits are equalized among the plurality of drive circuits DC1 and DC2 (DC3 and DC4), so that the characteristics of the respective drive circuits DC1 and DC2 (DC3 and DC4) can be substantially the same. Consequently, the light quantity of the respective light-emitting elements E can be in the predetermined range.

In addition, in the first embodiment, the contacts CT for electrically connecting the drive circuits DC1 and DC2 (DC3 and DC4) and the light-emitting elements E are arranged linearly in the longitudinal direction LGD. By arranging the contacts CT linearly, the conditions of manufacture of the respective contacts are equalized, so that the characteristics of the contacts CT can be substantially the same. Consequently, the light quantity of the respective light-emitting elements E can be within the predetermined range.

In particular, when removing insulating films formed once on the contacts CT through an etching process in the manufacturing process, the configuration in which the contacts CT are arranged linearly is satisfactory. In other words, by arranging the contacts CT linearly, etching rates of the respective contacts CT are substantially equalized, so that the contact resistances can be substantially the same. Consequently, the light quantity of the respective light-emitting elements E can be within the predetermined range.

As the contacts CT are formed by punching holes, variation in characteristics may occur often during manufacturing. Therefore, in terms of keeping the light quantity of the light-emitting elements E within the predetermined range, it is specifically preferable to arrange the contacts CT linearly in the longitudinal direction LGD and uniformizing the characteristics of the contacts CT described above.

In the line head 29 in the first embodiment, the light-emitting elements E are arranged in a zigzag pattern in the longitudinal direction LGD. The light quantity of the light-emitting elements E arranged in this manner is sensitive to the conditions of manufacture as described below. In other words, since the conditions of manufacture are different from each other between the light-emitting element E having different light-emitting elements E on both sides and the light-emitting elements E having a different light-emitting element E only on one side, the light quantity of the light-emitting elements E arranged at the both ends may be relatively lowered among the light-emitting elements E arranged in the longitudinal direction LGD. Therefore, the light-emitting elements E at the both ends are used for exposure, and the light-emitting elements E may not be able to emit light having the sufficient light quantity, so that the satisfactory exposure may not be achieved. In contrast, according to the line head 29 in the first embodiment, the dummy elements E are provided on both sides of the light-emitting elements E disposed in the longitudinal direction LGD, and the conditions of manufacture of at least the respective light-emitting elements E other than the dummy elements E are substantially equalized. On that basis, it is configured in such a manner that the light-emitting elements E other than the dummy elements E are connected to the drive circuits DC and emit light according to the drive current Ie, while the dummy elements E are not connected to the drive circuits DC so as not to emit light. In other words, only the light-emitting elements E being in the substantially same conditions of manufacture and having the sufficient light quantity are used for the exposure, and the dummy elements E are not used for the exposure. Accordingly, the satisfactory exposure is achieved using the light-emitting elements E having the sufficient light quantity.

In the first embodiment, the dummy elements E and the light-emitting elements E other than that are the organic EL elements having the same configuration. Therefore, the conditions of manufacture of the light-emitting elements E arranged in the longitudinal direction LGD can further be equalized.

In the first embodiment, in the respective light-emitting element groups EG, the arrangement of the light-emitting elements E and the arrangement of the drive circuits DC1 to DC4 are symmetry with respect to a centerline CL1 in the primary scanning direction MD (FIG. 5). Accordingly, the lengths of the wirings WLb are different between the center portion and the both end portions in the primary scanning direction MD, but the length of the wirings WLb at the both end portions are substantially the same. Therefore, the driving characteristics of the both end portions in the primary scanning direction MD and the light-emitting element E may be substantially equalized. Accordingly, the following advantage can be expected. In other words, the plurality of light-emitting element groups EG expose the areas adjacent to each other in the primary scanning direction MD. In this case, the light-emitting element E at an end of one light-emitting element group EG in the primary scanning direction MD and the light-emitting element E at an end of another light-emitting element group EG in the primary scanning direction MD form spots SP and SP at areas adjacent to each other in the primary scanning direction MD. Then, if the characteristics (diameters or light quantity) of the spots SP and SP are significantly different, density difference may occur in an image which is finally formed. In contrast, in the respective light-emitting element groups EG, by substantially equalizing the driving characteristics of the light-emitting elements E at the both end portions in the primary scanning direction MD, the characteristics of the spots SP and SP are substantially the same, so that the density difference can be suppressed.

In the same manner, in the respective light-emitting element groups EG, the arrangement of the light-emitting elements E and the arrangement of the drive circuits DC1 to DC4 are symmetry with respect to a centerline CL2 in the secondary scanning direction SD (FIG. 5). With such the arrangement, the density difference which may be generated due to reasons other than those described above is restrained. Therefore, as is understood from FIG. 5, the light-emitting element group EG includes the light-emitting elements E of the light-emitting element row ER1, the light-emitting elements E of the light-emitting element row ER3, the light-emitting elements E of the light-emitting element row ER2, and the light-emitting elements E of the light-emitting element row ER4 are arranged in this order at the pitch Pe3 in the primary scanning direction MD. In other words, the light-emitting elements E of the lower zigzag arrangement ZA12 in FIG. 5 and the light-emitting elements E of the upper zigzag arrangement ZA34 in FIG. 5 are arranged at the pitch Pe3 in the primary scanning direction MD. Therefore, when the driving characteristics of the light-emitting elements E are significantly different between the zigzag arrangement ZA12 and the zigzag arrangement ZA34, defective image formation such as the density differences appears at the pitch Pe3 in the image, which is finally formed thereby, may occur. In contrast, in the first embodiment, the arrangement of the light-emitting elements E and the arrangement of the drive circuits DC1 to DC4 are symmetry with respect to the centerline CL2 in the secondary scanning direction SD. Therefore, the patterns of the wirings WLb which connect the respective light-emitting elements E of the lower zigzag arrangement ZA12 and the drive circuits DC1, DC2, DC1, DC2 . . . and the wiring WLb connecting the respective light-emitting elements E of the lower zigzag arrangement ZA34 and the drive circuits DC3, DC4, DC3, DC4, . . . can be substantially the same. Consequently, the drive characteristics of the light-emitting elements E can be substantially equalized between the zigzag arrangement ZA12 and the zigzag arrangement ZA34, so that the generation of the density difference may be suppressed.

### Second Embodiment

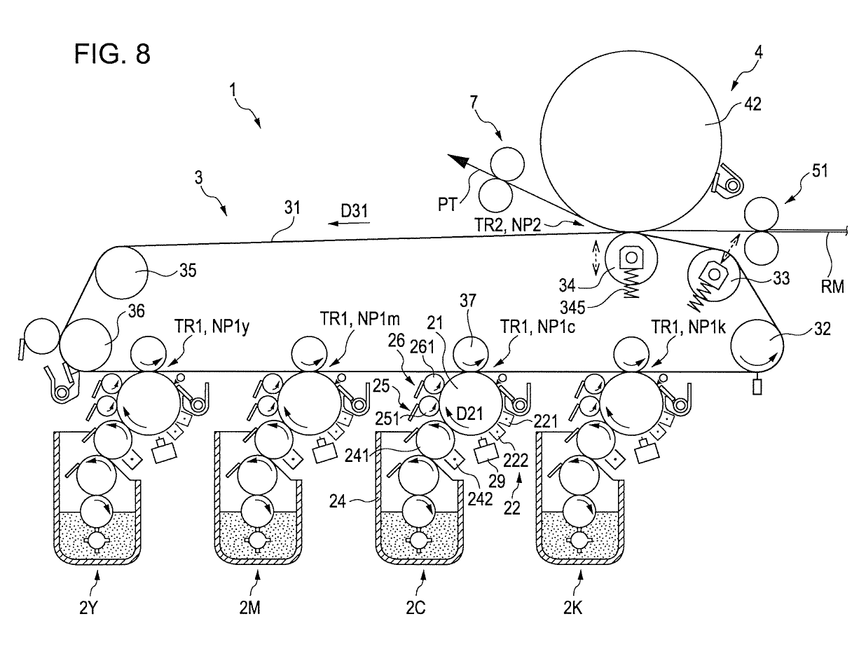

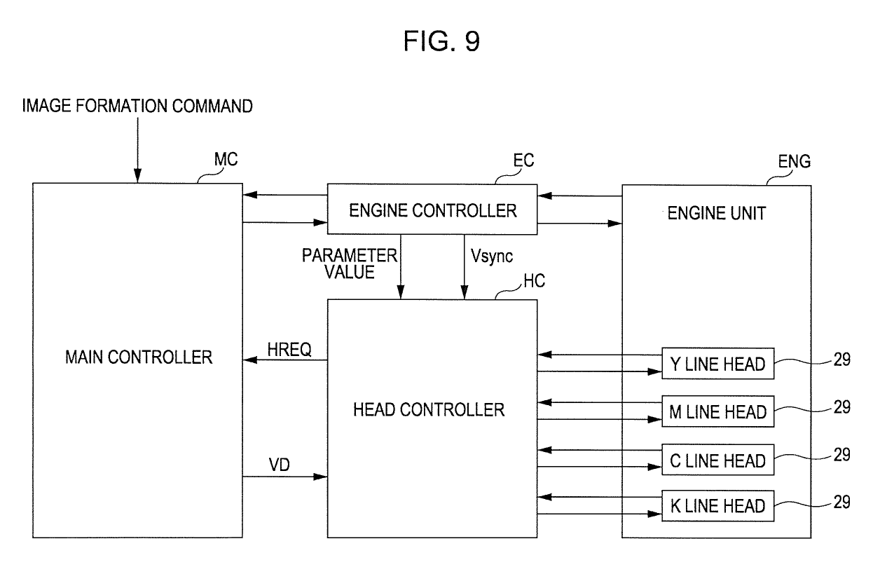

FIG. 8 is a drawing showing an example of an image forming apparatus to which the line head described above can be applied. FIG. 9 is a block diagram showing an electric configuration of the apparatus shown in FIG. 8. In a second embodiment, an example of the image forming apparatus provided with the above-described line head 29 will be described with reference to these drawings. An image forming apparatus 1 includes four image forming stations 2Y (for yellow), 2M (for magenta), 2C (for cyan), and 2K (for black) which form a plurality of images in different colors. Then, the image forming apparatus 1 is capable of being selectively operated in a color mode in which four colors of toner of yellow (Y), magenta (M), cyan (C), and black (K), are overlapped to form a color image and in a monochrome mode in which only black (K) toner is used to form a monochrome image.

In the image forming apparatus, when an image formation command is given from an external apparatus such as a host computer to a main controller MC having a CPU or a memory, the main controller MC provides control signals to an engine controller EC and the video data VD corresponding to the image formation command to a head controller HC. At this time, the main controller MC provides the video data VD corresponding to one line in the primary scanning direction MD to the head controller HC every time upon receipt of a horizontal request signal HREQ from the head controller HC. The head controller HC controls the line heads 29 in respective colors at the image forming stations 2Y, 2M, 2C, and 2K on the basis of the video data VD from the main controller MC and a vertical synchronous signal Vsync and a parameter value from the engine controller EC. Accordingly, an engine unit ENG performs a predetermined image forming action, and forms an image corresponding to the image formation command on a sheet-type recording medium RM such as copying paper, transfer paper, form, or OHP transparent sheet.

The respective image forming stations 2Y, 2M, 2C, and 2K have the same structure and functions except for the toner color. Therefore, in FIG. 8, only the components which constitute the image forming station 2C are designated by reference numerals, and reference numerals to be assigned to the remaining image forming stations 2Y, 2M, and 2K are not shown for easy understanding of the drawing. In the following description, the structure and the operation of the image forming station 2C will be described with reference to the reference numerals shown in FIG. 8. However, the structure and the operation of the remaining image forming stations 2Y, 2M, and 2K are the same except for the difference in toner color.

The image forming station 2C is provided with a photosensitive drum 21 on which a toner image in cyan is formed on the surfaces thereof. The photosensitive drum 21 is arranged in such a manner that axis of rotation thereof is arranged in parallel to or substantially parallel to the primary scanning direction MD (the direction vertical to a paper plane of FIG. 8), and is driven to rotate at a predetermined velocity in a direction indicted by an arrow D21 in FIG. 8. Accordingly, the surface of the photoconductor drum 21 is moved in the secondary scanning direction SD which is orthogonal or substantially orthogonal to the primary scanning direction MD.

Around the each photosensitive drum 21, a charger 22 as a corona charger configured to charge the surface of the photosensitive drum 21 to a predetermined potential, the line head 29 configured to expose the surface of the photosensitive drum 21 according to an image signal to form an electrostatic latent image, a developer 24 configured to visualize the electrostatic latent image as a toner image, a first squeezing portion 25, a second squeezing portion 26, and a cleaning unit configured to perform cleaning of the surface of the photosensitive drum 21 after the transfer are disposed in this order along the direction of rotation D21 of the photosensitive drum 21 (clockwise in FIG. 8).

In this embodiment, the charger 22 includes two corona chargers 221 and 222. The corona charger 221 is arranged on the upstream side of the corona charger 222 in the direction of rotation D21 of the photosensitive drum 21, so that charging is performed in two stages by the two corona chargers 221 and 222. The respective corona chargers 221 and 222 have the same configuration and do not come into contact with the surface of the photosensitive drum 21, and are scorotron chargers.

Then, the line head 29 forms the electrostatic latent image on the basis of the video data VD on the surface of the photosensitive drum 21 charged by the corona chargers 221 and 222. In other words, when the head controller HC sends the video data VD to the data transfer substrate TB (FIG. 7) of the line head 29, the data transfer substrate TB transfer the video data VD to the respective driver ICs 295, and the driver ICs 295 cause the respective light-emitting elements E to emit light on the basis of the video data VD. Accordingly, the surface of the photosensitive drum 21 is exposed and the electrostatic latent image corresponding to the image signal is formed. The detailed configuration of the line head 29 is as described above.

The toner is supplied from the developer 24 to the electrostatic latent image formed in this manner, and the electrostatic latent image is developed by the toner. The developer 24 of the image forming apparatus 1 includes a developing roller 241. The developing roller 241 is a cylindrical member, and is provided with a resilient layer such as polyurethane rubber, silicon rubber, NBR, or PFA tube on the outer peripheral portion of an inner core formed of metal such as iron. The developing roller 241 is connected to a developer motor, and rotates with the photosensitive drum 21 by being driven to rotate counterclockwise on the paper plane of FIG. 8. The developing roller 241 is electrically connected to a developing bias generator (constant-voltage power source), not shown, and is configured to be applied with a developing bias at satisfactory timings.

An anilox roller is provided for supplying liquid developer to the developing roller 241, and liquid developer is supplied from a developer storage unit to the developing roller 241 via the anilox roller. In this manner, the anilox roller has a function to supply the liquid developer to the developing roller 241. The anilox roller is a roller having a depression pattern such as a helical groove curved finely and uniformly on the surface for allowing the liquid developer to be carried easily. In the same manner as the developing roller 241, a roller having a rubber layer such as urethane or NBR wrapped around the metallic core, or having a PFA tube covered thereon is used. The anilox roller rotates by being connected to the developer motor.

As the liquid developer to be stored in the developer storage unit, instead of low concentration (1 to 2 wt %) and low viscosity volatile liquid developer having volatility at room temperatures and containing Isoper (Trade Mark: Exxson) as liquid carrier generally used in the related art, a high viscosity (on the order of 30 to 10000 mPa·s) liquid developer obtained by adding solid material of about 1 μm in average particle diameter including a coloring agent such as pigment dispersed therein to a high concentration and high viscosity resin having non-volatility at room temperatures into a liquid solvent such as organic solvent, silicon oil, mineral oil, or edible oil together with a dispersing agent to have a toner solid content concentration of about 20% is used.

The developing roller 241 having received supply of the liquid developer in this manner rotates synchronously with the anilox roller, and rotates so as to move in the same direction as the surface of the photosensitive drum 21, thereby transporting the liquid developer carried on the surface of the developing roller 241 to the developing position. In order to form the toner image, the developing roller 241 needs to rotate so that the surface thereof moves in the same direction as the surface of the photosensitive drum 21. However, it may be rotated either in the reverse direction or the same direction with respect to the anilox roller.

In the developer 24, a toner compaction corona generator 242 is arranged so as to oppose the developing roller 241 immediately on the upstream side of the developing position in the direction of rotation of the developing roller 241. The toner compaction corona generator 242 is an electric field applying unit configured to increase a charging bias on the surface of the developing roller 241 and is electrically connected to a toner charge generator (not shown) composed of a constant current power source. When a toner charging bias is applied to the toner compaction corona generator 242, an electric field is applied to the toner as the liquid developer transported by the developing roller 241 at a position near the toner compaction corona generator 242, so that the toner is charged and compacted. A compaction roller configured to charge by coming into contact may be used instead of the corona discharge on the basis of the application of the electric field for the toner charging and compaction.

The developer 24 configured in this manner is capable of reciprocating between the developing position where the latent image on the photosensitive drum 21 is developed and the retracted position where it is retracted from the photosensitive drum 21. Therefore, while the developer 24 is moved to the retracted position and settled, the supply of new liquid developer to the photosensitive drum 21 is stopped in the image forming station 2C for cyan.

The first squeezing portion 25 is arranged on the downstream side of the developing position in the direction of rotation D21 of the photosensitive drum 21, and the second squeezing portion 26 is arranged on the downstream side of the first squeezing portion 25. Squeezing rollers 251 and 261 are provided at these squeezing portions 25 and 26 respectively. The squeezing roller 251 rotates while receiving a rotary drive force from a main motor in a state of being in abutment with the surface of the photosensitive drum 21 at a first squeeze position, thereby removing excessive developer of the toner image. The squeezing roller 261 rotates while receiving the rotary drive force from the main motor in a state of being abutment with the surface of the photosensitive drum 21 at a second squeeze position on the downstream side of the first squeeze position in the direction of rotation D21 of the photosensitive drum 21, thereby removing excessive liquid carrier or fogged toner of the toner image. In this embodiment, in order to enhance the squeezing efficiency, a squeeze bias generator (constant-voltage power source), not shown, is electrically connected to the squeezing rollers 251 and 261, so that a squeezing bias is applied at satisfactory timings. Although two squeezing portions 25 and 26 are provided in this embodiment, the number and arrangement of the squeezing portions are not limited thereto and, for example, arrangement of only one squeezing portion is also applicable.

The toner image having passed through the squeezing positions is primarily transferred to an intermediate transfer member 31 of a transfer unit 3. The intermediate transfer member 31 is an endless belt as an image carrier which is capable of carrying a toner image temporarily on the surface thereof, more specifically, on the outer peripheral surface thereof, and is wound around a plurality of rollers 32, 33, 34, 35, and 36. The roller 32 is connected to the main motor, and functions as a belt drive roller which circulates the intermediate transfer member 31 in the direction indicated by an arrow D31 in FIG. 8. In this embodiment, in order to enhance the adhesiveness with respect to the recording medium RM and hence enhance the transfer properties of the toner image to the recording medium RM, a resilient layer is provided on the surface of the intermediate transfer member 31 so that the toner image is carried on the surface of the resilient layer.

Here, only the belt drive roller 32 described above is driven by the main motor from among the rollers 32 to 36 on which the intermediate transfer member 31 is wound, and other rollers 33 to 36 are driven rollers having no driving source. The belt drive roller 32 is wrapped by the intermediate transfer member 31 on the downstream side of a primary transfer position TR1 and on the upstream side of a secondary transfer position TR2, described later, in the direction of belt movement D31.

The transfer unit 3 includes a primary transfer backup roller 37, and the primary transfer backup roller 37 is disposed so as to oppose the photosensitive drum 21 with the intermediary of the intermediate transfer member 31. The outer peripheral surface of the photosensitive drum 21 comes into abutment with the intermediate transfer member 31 at the primary transfer position TR1 where the photosensitive drum 21 and the intermediate transfer member 31 come into abutment with each other to form a primary transfer nip portion NP1c. Then, the toner image on the photosensitive drum 21 is transferred to the outer peripheral surface (the lower surface at the primary transfer position TR1) of the intermediate transfer member 31. The toner image in cyan formed by the image forming station 2C is transferred to the intermediate transfer member 31. In the same manner, the transfer of the toner image is performed at the image forming stations 2Y, 2M and 2K as well, the toner images in respective colors are superimposed on the intermediate transfer member 31 in sequence, and a full color toner image is formed. In contrast, when forming a monochrome toner image, the transfer of the toner image to the intermediate transfer member 31 is performed only at the image forming station 2K corresponding to black color.

The toner image transferred to the intermediate transfer member 31 in this manner is transported to the secondary transfer position TR2 via a position wound around the belt drive roller 32. At the secondary transfer position TR2, a secondary transfer roller 42 of a secondary transfer unit 4 is positioned so as to oppose the roller 34 wrapped by the intermediate transfer member 31 with the intermediary of the intermediate transfer member 31, and the surface of the intermediate transfer member 31 and the surface of the transfer roller 42 come into abutment with each other to form a secondary transfer nip portion NP2. In other words, the roller 34 functions as a secondary transfer backup roller. The rotating shaft of the backup roller 34 is supported by a pressing unit 345 which is a resilient member such as a spring resiliently so as to be capable of moving toward and away from the intermediate transfer member 31.

At the secondary transfer position TR2, a single color or a plurality of colors of toner images formed on the intermediate transfer member 31 is transferred to the recording medium RM transported from a pair of gate rollers 51 along a transporting path PT. The recording medium RM on which the toner image is secondarily transferred is fed from the secondary transfer roller 42 to a fixing unit 7 provided on the transporting path PT. In the fixing unit 7, fixation of the toner image to the recording medium RM is performed by applying heat or pressure to the toner image transferred to the recording medium RM. In this manner, a desired image can be formed on the recording medium RM.

### Others

In this manner, in the embodiments described above, the line head 29 corresponds to the “exposure head”, the photosensitive drum 21 corresponds to the “latent image carrier”, the drive circuits DC1 to DC4 correspond to the “drive circuit”, the contacts CT corresponds to the “contacts”, the pitch Pe2 corresponds to the “first pitch”, the pitch Pdc corresponds to the “second pitch”, the longitudinal direction LGD corresponds to a “first direction”, and the width direction LTD corresponds to a “second direction” in the aspect of the invention. The light-emitting elements E correspond to the “light-emitting element” or the “first light-emitting elements” in the aspect of the invention. The dummy elements E correspond to the “second light-emitting elements” in the aspect of the invention.

The invention is not limited to the embodiments described above, and various modifications may be made without departing the scope of the invention in addition to the configuration described above. For example, in the light-emitting element group EG in the above-described embodiment, the light-emitting elements E formed two each at both end portions of the longitudinal direction LGD from among the plurality of light-emitting elements E which constitute the zigzag arrangements ZA12 (ZA34) function as the dummy elements E. In other words, two each of the dummy elements E are arranged respectively at the both ends of the zigzag arrangements ZA12 (ZA34). However, the number of the dummy elements E is not limited thereto, and one or two or more dummy elements E may be provided respectively at both ends of the zigzag arrangements ZA12 (ZA34).

Other configurations of the light-emitting element group EG are not limited to those described above, and the number of the light-emitting element rows ER which constitute the light-emitting element group EG, or the number of the light-emitting elements E may also be modified.

In the embodiment described above, the drive circuits DC are formed of the low-temperature polysilicon thin film transistor. However, the drive circuits DC may be formed by using various types of thin film semiconductor circuits such as high-temperature polysilicon thin film transistors, amorphous silicon thin film transistors, or induced thin-film transistors.

Also, in the embodiment described above, the bottom-emission type organic EL elements are used as the light-emitting elements E. However, top-emission type organic EL elements may be used as the light-emitting elements E, or light emitting diodes (LEDs) other than the organic EL elements or the like may be used as the light-emitting elements E.

The entire disclosure of Japanese Patent Applications No. 2009-267675, filed on Nov. 25, 2009 is expressly incorporated by reference herein.

What is claimed is:

1. An exposure head comprising:
light-emitting elements disposed at a first pitch in a first direction; and
drive circuits disposed at a second pitch wider than the first pitch in the first direction on one side of the light-emitting elements in a second direction orthogonal to or substantially orthogonal to the first direction and configured to cause the light-emitting elements to emit light.

2. The exposure head according to claim 1, wherein the drive circuits are disposed linearly in the first direction.

3. The exposure head according to claim 1, further comprising contacts disposed in the first direction between the light-emitting elements and the drive circuits, wherein the light-emitting elements and the drive circuits are electrically connected via the contacts.

4. The exposure head according to claim 3, wherein the contacts are disposed linearly in the first direction.

5. An image forming apparatus comprising:
an exposure head having light-emitting elements disposed at a first pitch in a first direction; and
a latent image carrier to be exposed to light emitted from the light-emitting elements,
wherein the exposure head includes drive circuits disposed at a second pitch wider than the first pitch in the first direction on one side of the light-emitting elements in a second direction orthogonal to or substantially orthogonal to the first direction and configured to cause the light-emitting elements to emit light.

6. An exposure head comprising:
first light-emitting elements disposed in a first direction;
second light-emitting elements disposed on both sides of the first light-emitting elements in the first direction; and
drive circuits configured to generate drive signals,
wherein the first light-emitting elements are connected to the drive circuits and emit light according to the drive signals, while the second light-emitting elements are not connected to the drive circuits and do not emit light.

7. The exposure head according to claim 6, wherein the first light-emitting elements and the second light-emitting elements are organic EL elements having the same configuration.

8. An image forming apparatus comprising:
an exposure head including first light-emitting elements disposed in a first direction, second light-emitting elements disposed on both sides of the first light-emitting elements in the first direction, and drive circuits configured to generate drive signals; and
a latent image carrier, wherein
the first light-emitting elements are connected to the drive circuits and emit light according to the drive signals to expose the latent image carrier, while the second light-emitting elements are not connected to the drive circuits and do not emit light.
